(19) United States
(12) Patent Application Publication
(10) Pub. No.: US 2025/0165795 A1
(43) Pub. Date: May 22, 2025

(54) REDUCTION OF THIN VOLUME ASSEMBLIES USING REINFORCEMENT LEARNING

(71) Applicant: National Technology & Engineering Solutions of Sandia, LLC, Albuquerque, NM (US)

(72) Inventors: Steven J. Owen, Carlsbad, CA (US); Corey Devan Ernst, American Fork, UT (US); Armida J. Carbajal, Albuquerque, NM (US); Matthew Gregor Peterson, Albuquerque, NM (US)

(21) Appl. No.: 18/513,711

(22) Filed: Nov. 20, 2023

(51) Int. Cl. G06N 3/092; G06N 3/09

(52) U.S. Cl. CPC G06N 3/092; G06N 3/09

(57) ABSTRACT

A computer-implemented method for reducing thin volume assemblies and generating sheet bodies using reinforcement learning is provided. The method comprises establishing respective agents for thin volumes and selecting actions for reducing the thin volumes. The method comprises assigning initial rewards to the actions for each agent. The method comprises executing the selected actions by the agents and assigning rewards to the selected actions based on a reward policy. The method comprises continuing the reinforcement learning until at least one stopping criterion is met.

### STATEMENT OF GOVERNMENT INTEREST

This invention was made with United States Government support under Contract No. DE-NA0003525 awarded by the United States Department of Energy/National Nuclear Security Administration. The United States Government has certain rights in this invention.

### BACKGROUND INFORMATION

### 1. Field

The present disclosure relates generally to reduction of thin volume assemblies, and more specifically to a method and system for reduction of thin volume assemblies using reinforcement learning.

### 1. BACKGROUND

In computer-aided design (CAD) assemblies, reduction of thin volumes is used to simplify complex geometries and improve computational efficiency of simulations and analysis. Reduction of thin volumes is used in shell modeling, where thin-walled structures are represented using two-dimensional elements, such as shells or plates, instead of solid elements.

In CAD assemblies, some components may have thin volumes or thin-walled structures that do not significantly contribute to the overall structural integrity or behavior of a model. Examples of thin volumes or thin-walled structures include sheet metal components, thin panels, or skin surfaces of certain products. The reduction of thin volumes involves identifying and simplifying thin-walled regions to reduce the model's complexity. Thin-walled components can be represented using shell elements instead of solid elements, which significantly reduces the number of elements and nodes in the model.

In automotive and aerospace industries, many components are made from sheet metal. When conducting structural analysis on assemblies, the reduction of thin-walled components or structures allows engineers to focus computational resources on critical areas while neglecting non-critical regions without compromising the overall accuracy of the analysis. In design optimization processes, thin-walled regions can be removed or simplified without affecting the structural performance, leading to lighter and more efficient designs.

In simulation and analysis of three-dimensional solid models, solving systems of equations can be computationally expensive. By reducing, eliminating or simplifying thin-walled structures, a model's complexity is reduced, which leads to faster simulations and analyses. Smaller and simpler models require less memory and storage, making it easier to handle large assemblies and improve overall CAD software performance.

### SUMMARY

An illustrative embodiment provides a computer-implemented method for reducing thin volume assemblies and generating sheet bodies using reinforcement learning. The method comprises establishing respective agents for thin volumes and selecting actions for reducing the thin volumes. The method comprises assigning initial rewards to the actions for each agent. The method comprises executing the selected actions by the agents and assigning rewards to the selected actions based on a reward policy. The method comprises continuing the reinforcement learning until at least one stopping criterion is met.

In an illustrative embodiment, the agents are responsible for selecting their actions and maintaining the actions' reward history. The actions include reducing thin copy operations and mid-surface operations. The actions are selected from known actions using a decision policy that allows for exploitation of a state space utilizing supervised learning predictions to exploit knowledge gained from previous iterations of the supervised learning predictions. The stopping criteria include reaching a predefined number of iterations or achieving a specified level of convergence of rewards for the actions.

In an illustrative embodiment, the actions comprise reduction actions and connection actions. The reduction actions are performed before the connection actions to ensure thin volume reduction before extending, imprinting and merging neighboring sheet bodies. The actions are assigned rewards based on a reward policy that considers geometric integrity and connection relationships between the thin volumes and neighboring sheet bodies.

Another illustrative embodiment provides a system for reducing thin volume assemblies and generating sheet bodies using reinforcement learning. The system comprises a storage device configured to store program instructions. The system comprises one or more processors operably connected to the storage device. The processors are configured to execute the program instructions to cause the system to: establish respective agents for thin volumes; select actions for reducing the thin volumes; assign initial rewards to the actions for each agent; execute the selected actions by the agents; assign rewards to the selected actions based on a reward policy; and continue the reinforcement learning until at least one stopping criterion is met.

Another illustrative embodiment provides a computer program product for reducing thin volume assemblies and generating sheet bodies using reinforcement learning. The computer program product comprises a computer-readable storage medium having program instructions embodied thereon to perform the steps of: establishing respective agents for thin volumes; selecting actions for reducing the thin volumes; assigning initial rewards to the actions for each agent; executing the selected actions by the agents; assigning rewards to the selected actions based on a reward policy; and continuing the reinforcement learning until at least one stopping criterion is met.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing system in which illustrative embodiments may be implemented;

FIG. 2 is a block diagram of a system for reduction of thin volumes;

FIGS. 3A-3C illustrate three operations for reducing thin volumes;

FIGS. 4A-4C illustrate feasibility of reduction operations performed on thin volumes;

FIGS. 4D-1, 4D-2 and 4E-4F show Tables which include sets of features computed for a thin volume;

FIGS. 5A-5C illustrate reduction solutions for an example thin volume;

FIG. 6 illustrates different connection types for thin volumes;

FIG. 7 depicts a flowchart of a process for reduction for thin volumes;

FIG. 8 depicts a flowchart of a process for generating reduce actions for thin volumes;

FIG. 9 depicts a flowchart of a process for generating connection actions for thin volumes;

FIG. 10 depicts a flowchart of a process for choosing actions for thin volumes;

FIG. 11 depicts a flowchart of a process for choosing a reward policy; and

FIG. 12 illustrates a block diagram of a data processing system in accordance with an illustrative embodiment.

### DETAILED DESCRIPTION

The illustrative embodiments recognize and take into account one or more different considerations. The illustrative embodiments recognize and take into account that in computer-aided design (CAD) assemblies, there is a need to simplify complex geometries and improve computational efficiency of simulations and analysis.

The illustrative embodiments also recognize and take into account that in simulation and analysis of three-dimensional solid models, solving systems of equations can be computationally expensive. Using shell elements for thin regions significantly decreases the computational effort. By reducing, eliminating or simplifying thin-walled structures, a model's complexity is reduced, which leads to faster simulations and analyses.

The illustrative embodiments also recognize and take into account that smaller and simpler models require less memory and storage, making it easier to handle large CAD assemblies and improve overall CAD software performance.

The illustrative embodiments address various limitations associated with current techniques. The illustrative embodiments address the lack of intelligent decision-making of current techniques. For example, geometric reasoning-based methods often rely on predefined rules and heuristics, lacking the adaptability and intelligent decision-making capabilities of machine learning approaches.

The illustrative embodiments address high computational overhead of current techniques when dealing with complex thin volume assemblies, leading to longer modeling times.

The illustrative embodiments address the difficulty in preserving geometric and topological information in current techniques. Traditional algorithms struggle to preserve the original geometric and topological integrity of the model during dimensional reduction, leading to potential inaccuracies.

The illustrative embodiments provide a method and system for reduction of thin volume assemblies using reinforcement learning. In some illustrative embodiments, a multi-agent reinforcement learning method, including supervised learning, is employed to find a structured sequence of operations to reduce a CAD assembly comprising a set of 3D thin volumes. The illustrative embodiments utilize a machine learning classification procedure (e.g., CubitEDT) to identify thin volumes. A machine learning predictions algorithm (e.g., CubitEDT) is then used to generate a suitability score for a series of reduction operations on each thin volume. The reinforcement learning employs a supervised learning approach that predicts the suitability of dimensional reduction. The supervised learning approach assigns rewards and penalties to construct shell model assemblies and to generate a structured sequence of CAD operations or commands that can be verified, modified, and archived.

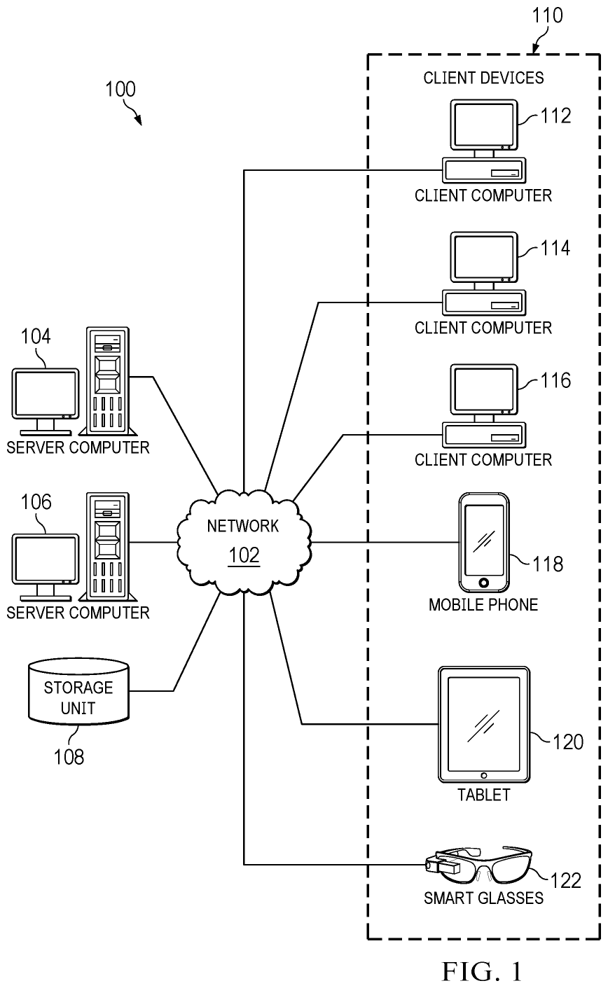

With reference to FIG. 1, a pictorial representation of a network of a data processing system is depicted in which illustrative embodiments may be implemented. Network data processing system 100 is a network of computers in which the illustrative embodiments may be implemented. Network data processing system 100 contains network 102, which is the medium used to provide communications links between various devices and computers connected within network data processing system 100. Network 102 may include connections, such as wire, wireless communication links, or fiber optic cables.

In the depicted example, server computer 104 and server computer 106 and storage unit 108 connect to network 102. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computer 112, client computer 114, and client computer 116. Client devices 110 can also include other types of client devices such as mobile phone 118, tablet computer 120, and smart glasses 122.

In the illustrative example of FIG. 1, server computer 104 and server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Program code located in network data processing system 100 can be stored on a computer-recordable storage medium and downloaded to a data processing system or other device for use. For example, the program code can be stored on a computer-recordable storage medium on server computer 104 and server computer 106 and storage unit 108 and downloaded to client devices 110 over network 102 for use on client devices 110.

In the illustrative example of FIG. 1, network 102 can be the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using different types of networks. For example, network 102 can be comprised an intranet, a local area network (LAN), a metropolitan area network (MAN), or a wide area network (WAN). FIG. 1 is intended as an example, and not as an architectural limitation for the different illustrative embodiments.

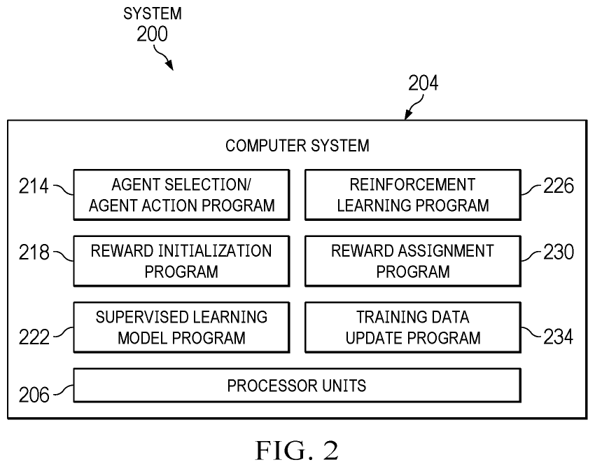

FIG. 2 is a block diagram of system 200 for reduction of thin volume assemblies in accordance with an illustrative embodiment. System 200 comprises computer system 204 which is a physical hardware system and includes one or more data processing systems. When more than one data processing system is present in computer system 204, those data processing systems are in communication with each other using a communications medium. The data processing systems can be selected from at least one of a computer, a server computer, a tablet computer, or some other suitable data processing system.

In the illustrative example, the hardware system can take a form selected from at least one of discreet circuits, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As depicted, computer system 204 includes a number of processor units 206 that are capable of executing program codes implementing processes in the illustrative examples. As used herein, a processor unit in the number of processor units 206 is a hardware device and is comprised of hardware circuits such as those on an integrated circuit that respond and process instructions and program code that operate a computer. When a number of processor units 206 execute program codes for a process, the number of processor units 206 is one or more processor units that can be on the same computer or on different computers. In other words, the process can be distributed between processor units on the same or different computers in a computer system. Further, the number of processor units 206 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

Computer system 204 includes agent selection/agent action program 214. Agent selection/agent action program 214 includes program code for assigning an agent for each thin volume. The agent is responsible for selecting an action and managing its topological relationship with neighboring volumes.

Computer system 204 includes reward initialization program 218 which includes program code configured to enable each agent to assign an initial reward to its actions. Alternatively, rewards can be predicted using a supervised learning model program 222.

Computer system 204 includes reinforcement learning program 226 which includes program code to enable the agents to select a reduction action from a list of known reduction actions. The selected actions are executed by the agents by, for example, performing reduction operations and connection operations.

Computer system 204 includes reward assignment program 230 which includes program code configured to enable each agent to assign a reward to its selected action based on a reward policy. The assigned rewards can be recorded in the agent's history.

Computer system 204 includes training data update program 234 which includes program code for updating training data with the rewards and thereby creating a new learning model.

The illustration of system 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

In some illustrative embodiments, a supervised machine learning model capable of predicting reduction operations for individual thin volumes is created. The supervised learning model serves as a core component of a reinforcement learning procedure for reduction of thin volumes and generation of sheet bodies.

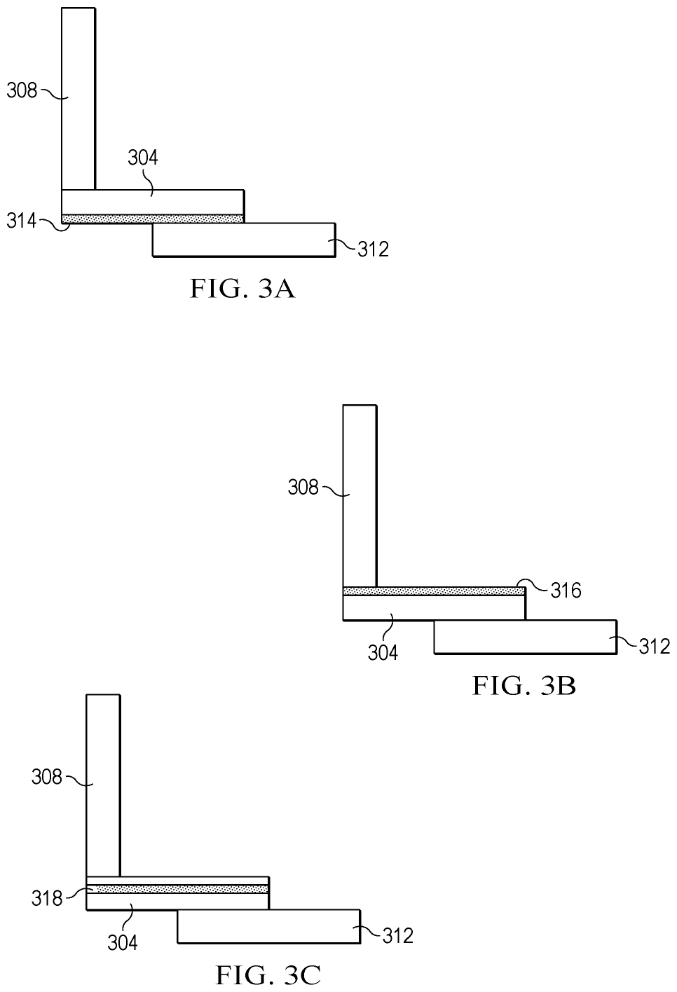

Turning now to FIGS. 3A-3C, three operations for reducing a 3D thin volume 304 to a sheet body in accordance with an illustrative embodiment are depicted. The three operations represent three different options for reducing volume 304 to the sheet body. The operations are considered in relation to volume 308 and volume 312 because volume 308 and volume 312 influence which of the three operations is selected as a reduced representation for volume 304.

In FIG. 3A, a first copy surface operation is illustrated in which surface 314 of volume 304 is copied to represent a sheet body. In FIG. 3B, a second copy surface operation is illustrated in which surface 316 of volume 304 is copied to represent the sheet body. In FIG. 3C, an operation is illustrated in which mid-surface 318 represents the sheet body.

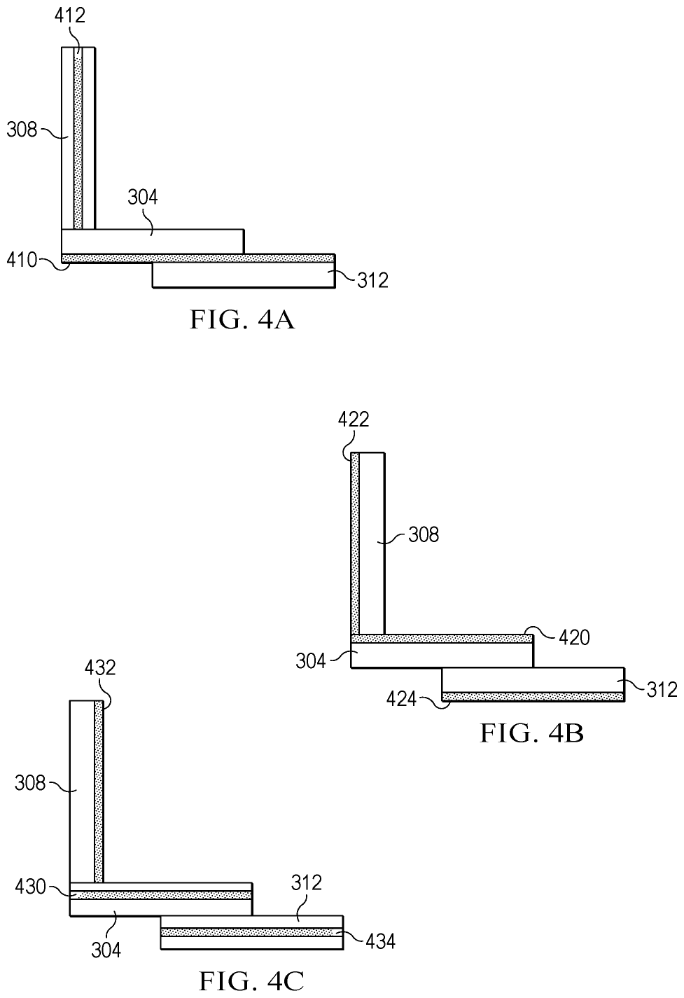

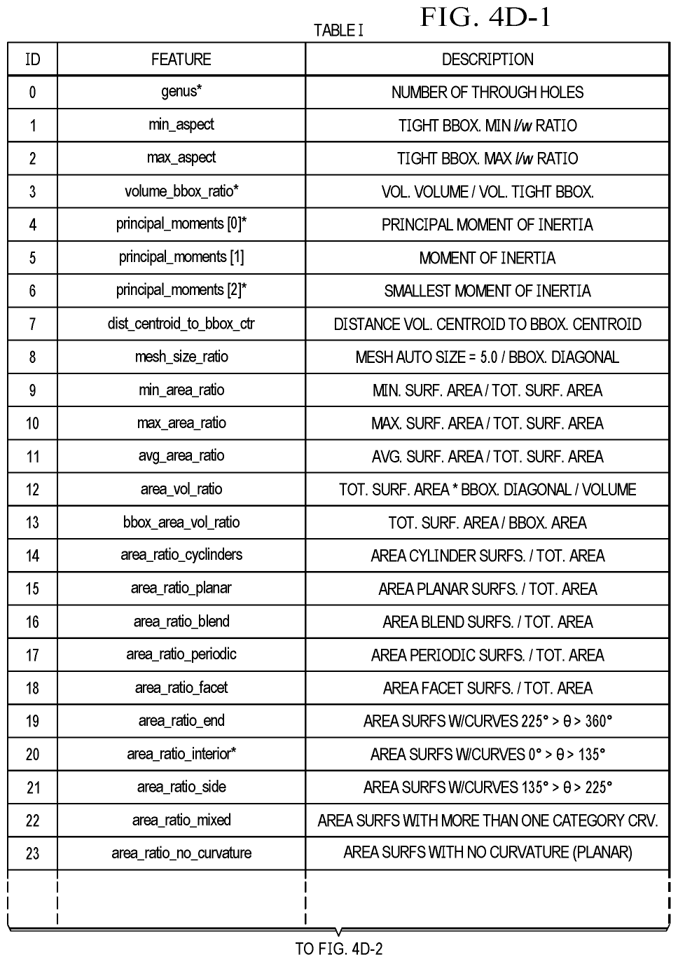

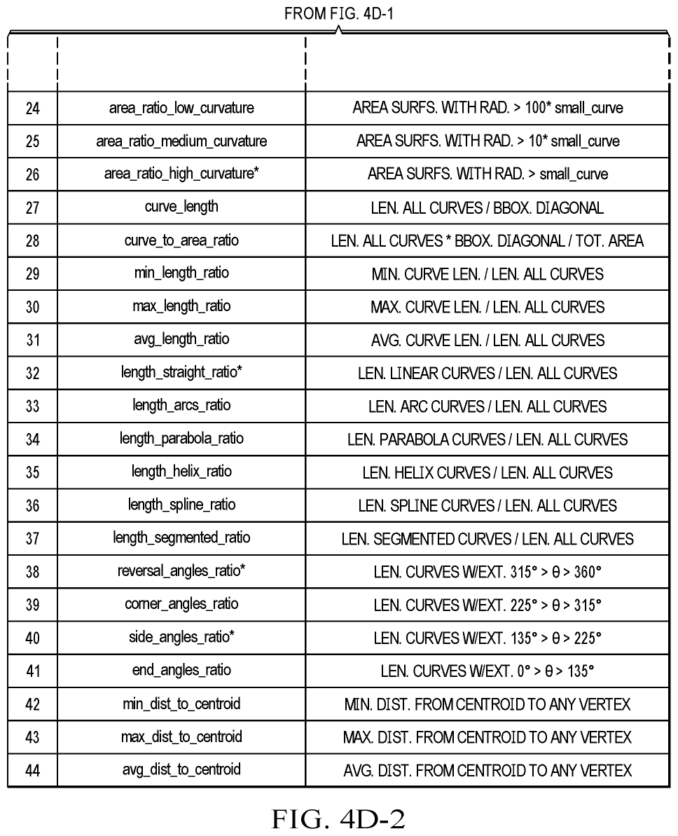

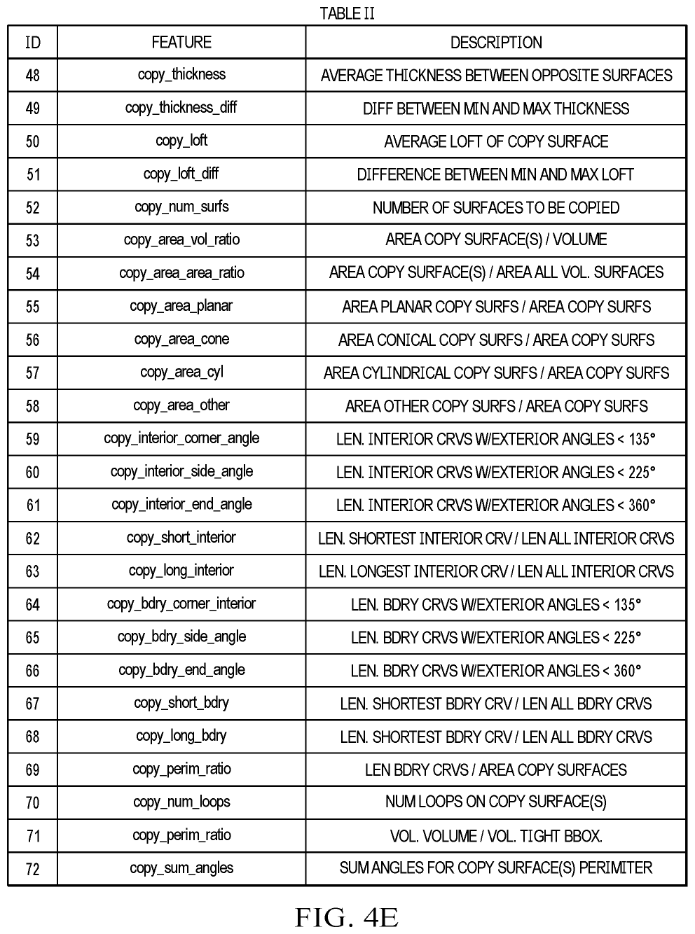

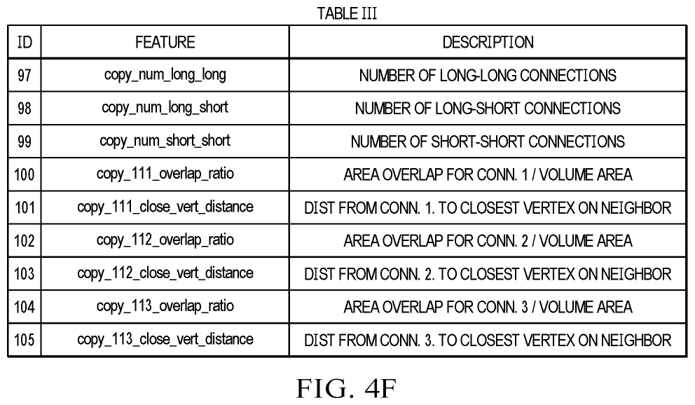

FIGS. 4A-4C illustrate feasibility of reduction operations performed on volume 304, volume 308 and volume 312. In FIG. 4A, surface 410 is selected as a reduction solution for volume 304 and volume 312, and surface 412 is selected as a reduction solution for volume 308. Surface 410 forms a long-long connection, where volume 304 and volume 312 share a common plane, allowing for the reduction solution that maintains contiguous connection between the resulting sheet bodies of volume 304 and volume 312. On the other hand, surface 412 as a reduction solution for volume 308, creates a gap between surface 410 and surface 412. However, this gap can be eliminated by a tweak surface operation that extends a surface in its plane to establish a contiguous connection between volume 304 and volume 308.

In FIG. 4B, surface 420 is selected as a reduction solution for volume 304, surface 422 is selected as a reduction solution for volume 308, and surface 424 is selected as a reduction solution for volume 312. The reduction solutions depicted in FIG. 4B are infeasible because it is not possible to establish a contiguous connection between volume 304 and volume 312. Furthermore, in this scenario, employing different reduction solutions between volume 304 and volume 308 may lead to the creation of sliver surfaces or small curves, potentially undermining the suitability of the solution.

In FIG. 4C, surface 430 is selected as a reduction solution for volume 304, surface 432 is selected as a reduction solution for volume 308, and surface 434 is selected as a reduction solution for volume 312. The suitability of the reduction solutions depicted in FIG. 4C is also questionable. A gap between surface 430 and surface 432 may be eliminated by a tweak surface operation that extends a surface in its plane to establish a contiguous connection between volume 304 and volume 308. However, it is not possible to establish a contiguous connection between volume 304 and volume 312.

In some example embodiments, a supervised machine learning algorithm is used to train a machine learning model which can predict a suitability score of a reduction solution. The trained machine learning model is a mapping function which maps input features (e.g., reduction solutions) to outputs (e.g., suitability scores). A score of 1.0, for example, indicates the optimal reduction solution, while a score of 0.0 indicates an infeasible reduction solution. Scores between 0 and 1 indicate successful solutions, but alternative solutions may still be preferable. The supervised machine learning algorithm uses a training dataset to train the model. A training dataset, for example, can comprise (x₁, y₁), . . . , (xₙ, yₙ), where x represents vector input features, y represents vector output features, and y=f(x) represents the mapping function that maps vector input features to suitability scores.

In some example embodiments, an enhanced set of features is incorporated into the supervised machine learning model for thin volume reduction. The enhanced set of features includes characteristics of a specific thin volume and reduction operations (e.g., first copy surface, second copy surface or mid-surface). The enhanced set of features also takes into account the influence of neighboring volumes. In some example embodiments, the enhanced set of features incorporate the following characteristics:

(1) Volume Characteristics: These features describe the properties of the volume, such as its shape, size, orientation, and geometric attributes.

(2) Operation Information: These features provide data related to the intended operation (copy or mid-surface) and the surfaces that may be affected by the operation.

(3) Contextual Information: These features indicate the relationship between the volume and its immediate neighbors, including shared surfaces, connectivity, and any potential impact on the reduction solution.

By incorporating these enhanced features into the supervised machine learning model, a comprehensive representation is created that includes the individual characteristics of the thin volume and its interaction with neighboring volumes, thus enabling accurate predictions of the suitability score for reduction operations.

As an example, FIGS. 4D-1 and 4D-2 show Table I which includes enhanced sets of features which are computed for a thin volume. The computed features are used as training data.

In some example embodiments, additional features that characterize one or more surfaces of a thin volume are computed and used as training data. FIG. 4E shows Table II which provides an example of additional features that characterize one or more surfaces.

In some example embodiments, features that characterize connections with neighbors are used as training data. FIG. 4F shows Table III which provides example features that characterize connections with neighbors.

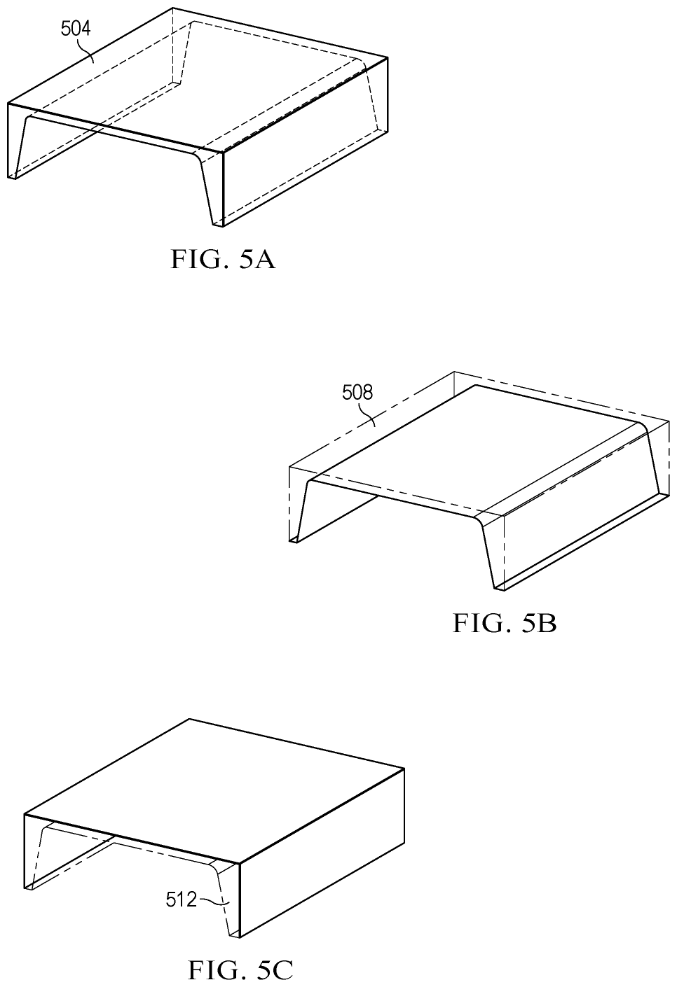

FIG. 5A illustrates a thin volume 504, and FIGS. 5B and 5C illustrate reduction solutions for volume 504. Because of the complex shape of volume 504, a number of surfaces are needed to represent volume 504. FIG. 5B illustrates a reduction solution 508 with 7 surfaces which represent volume 504. FIG. 5C illustrates a reduction solution 512 with 3 surfaces which represent volume 504. The surfaces in reduction solution 508 have different characteristics than the surfaces in reduction solution 512. Depending on the number of surfaces chosen to represent a reduction solution of a 3D thin volume, the number of surfaces may have different characteristics.

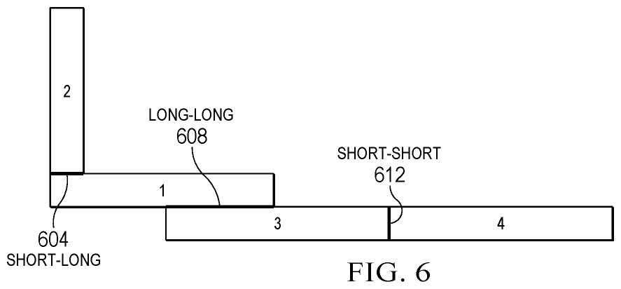

FIG. 6 illustrates three different connections that are used to characterize a thin volume within the context of its neighbors. A short-long connection 604 connects an end of volume 2 to a side of volume 1. A long-long connection 608 connects two sides so that volumes 1 and 3 share at least one co-planar surface that overlap. A short-short connection 612 connects two ends so that volumes 3 and 4 have coplanar surfaces, but do not overlap.

In some example embodiments, a reinforcement learning method is employed to find a sequence of operations to reduce a CAD assembly comprising a set of 3D thin volumes. Reinforcement learning does not require labeled input-output pairs like supervised learning does. Reinforcement learning requires structured rules and rewards about the environment for a primary decision maker for a system to explore it. The primary decision maker is referred to as an agent in the present disclosure. Reinforcement learning method requires the following:
(1) a state space (S) where the agent can explore;
(2) a set of actions (A) that the agent can take;
(3) a decision policy (P) that determines the probability of taking an action (a) in a given state (s); and
(4) a reward policy (R) that grants a reward (r) from transition from a state (s) to a state (s′) by taking an action (a).

In reinforcement learning, the goal of the agent is to find a policy 71, mapping the states to actions, that maximizes a measure of reinforcement (i.e., a reward). The agent finds the policy 7L through iterations of taking an action and receiving a reward from the environment. In some cases, there are multiple agents in the environment either trying to find a communal goal or individual/competitive goals which is known as multi-agent reinforcement learning.

At every iteration, the agent chooses the optimal action (a) from the set of actions A, based on its decision policy P and its current state (s) at an iteration (t). The policy π(a, s) can be expressed by the relationship: π(a, s)=P(at =a|st=s).

At first, the agent knows nothing about its environment and performs very poorly, randomly exploring the space. However, over time the agent records the rewards it encounters and builds the policy 7L. In some cases, a technique known as explore and exploit is used to learn about the space and then use what is learned. During the explore phase the agent tries as many state action pairs as possible to learn the associated rewards. Then in the exploit phase the agent uses its decision policy to maximize its reward.

In some example embodiments, in a multi-agent reinforcement learning implementation, an initial state space (S) is defined as a network of input volumes where each input volume is assigned its own agent. Each agent is responsible for producing and executing a set of reduction actions (A). In some example embodiments, the set of reduction actions include running program code which includes algorithms to convert a thin volume into a sheet body. For example, Cubit©R program commands may be used to convert a thin volume into a 3D manifold representation. For simple volumes, three primary Cubit©R program commands for reduction actions are available: two copy surfaces (i.e., inner plane and outer plane) and mid-surface. Each agent invokes a decision policy (P) to choose one of its valid reduction actions. Additional commands including tweaks and extends may be executed.

In some example embodiments, after the reduction actions, a reward policy (R) is executed to evaluate how well connections between volumes are preserved. According to the reward policy, each agent is given a reward between zero and one depending on how well connections between volumes are preserved. Rewards can be calculated based on various criteria including the percentage of connections preserved. For example, if a volume has three neighbors and after the conversion to a sheet body it only maintains two of those neighbors, then the reward given to the agent is ⅔. Penalties are also applied if a small curve or a narrow surface is generated. The penalties can occur when combinations of reduction and tweak-extend operations result in conditions that are less favorable to meshing. This process of the agent choosing an action and receiving a reward is repeated until either the average reward exceeds a user defined threshold or a maximum number of iterations is reached.

In some example embodiments, in order for the agent to maximize its action choices, the agent maintains a history of past rewards that were received based on past actions. In some example implementations, the agent keeps an array of received rewards for each action it can take. When prompted to choose a new action to take, the agent takes a linearly weighted average, favoring more recent rewards, for each of the action history arrays and chooses the action with the highest score.

In some example embodiments, a random action parameter is introduced that can be adjusted to allow the agent to ignore an action which has the highest score and instead randomly choose an action. This allows the agent to effectively explore the action space and avoid local minimas.

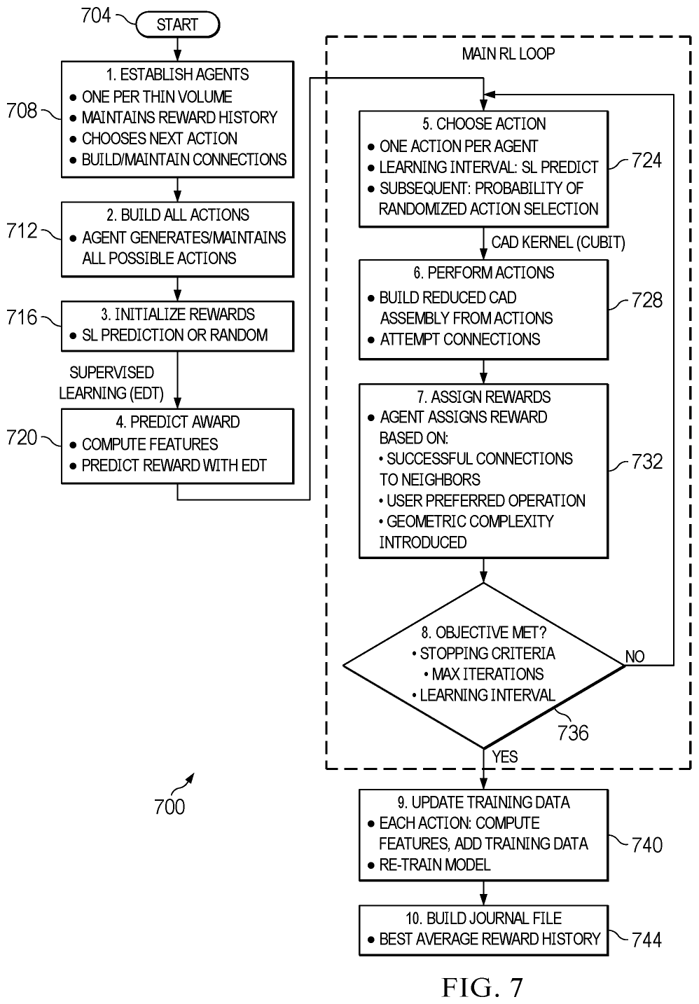

FIG. 7 depicts a flowchart of process 700 for applying reinforcement learning for reduction of thin volume and generation of sheet bodies in accordance with an illustrative embodiment. Process 700 establishes individual agents for each thin volume and tracks connection relationships between the thin volumes and the agents. The reinforcement learning process iteratively selects actions, performs operations (e.g., Cubit©R operations), assigns rewards based on the outcome, and updates training data.

Process 700 starts at step 704. Each thin volume in a state space is represented by a dedicated agent responsible for selecting an action, maintaining its reward history, and managing its topological relationship with neighboring volumes (step 708). A graph structure is constructed to track the connection relationships between the thin volumes and the agents. In some example embodiments, imprint and merge operations in Cubit©R program are performed to connect 3D thin volumes. The resulting merged surfaces serve as the basis for expected connections between the sheet bodies. Once the connections are established, the operations are undone to revert to the original 3D thin volumes, thus ensuring the preservation of the original thin volumes.

Next, all possible actions for reducing a given thin volume are generated (step 712). In some illustrative embodiments, these actions may either be a reduce thin copy or a midsurface Cubit©R command. An initial culling of the actions is performed to exclude those actions that are infeasible or considered poor solutions.

Next, each agent assigns an initial reward to its actions (step 716). In some example embodiments, values ranging from zero to one may be assigned as the rewards, where zero indicates an infeasible solution and one represents the most suitable solution for the given thin volume.

In some illustrative embodiments, rewards can be predicted using a supervised learning model (step 720). The features for the operation (e.g., copy or mid-surface) are computed and used to predict the rewards. For actions with limited training data or dissimilar geometry and neighbors, the initial predictions may be less accurate. As the reinforcement learning process progresses and more training data is accumulated, the predictions improve. Alternatively, random values can be assigned to initialize rewards, thus allowing for maximum exploration during the learning process.

In each reinforcement learning iteration, the agents select an action from their list of known reduction actions based on a decision policy (step 724). The decision policy allows for both exploration and exploitation of learning modes, thereby incorporating randomness to explore the action space and utilizing supervised learning predictions to exploit the knowledge gained from previous iterations.

The selected actions are executed by the agents (step 728). In some illustrative embodiments, the selected actions are executed using Cubit©R CAD kernel. First, reduction actions are performed, followed by connection actions that extend, imprint, and merge neighboring sheet bodies.

Each agent assigns a reward to its selected action based on a reward policy (step 732). The assigned rewards are recorded in the agents' history.

The reinforcement learning process continues until a stopping criteria is met (step 736). In some illustrative embodiments, the reinforcement learning process continues until at least one of the following stopping criteria is met:
a) t_{c}>max_iters, where t, is the number of successfully completed reinforcement learning iterations, and max_iters is the maximum number of iterations allowed;
b) R_{tc}≥stopping_criteria, where R_{tc}=Σrₐ/Nₐ, where rₐ represents the average agent reward at iteration t_{c} for Nₐ agents; or
c) user aborts the process: at any iteration t_{c}<max_iters, the user can choose to cancel the learning procedure if they deem the learning to be sufficient.

If one of the stopping criteria is met, the training data is updated, and a new learning model is constructed (step 740). The rewards ra assigned to each action across all agents are used as the ground truth labels for the supervised learning model. If the reinforcement learning process is terminated, the rewards from the reinforcement learning iteration with the highest reward t_{best} are used to augment the supervised learning model. If the reinforcement learning process is ongoing, the supervised learning model is updated at each learning interval with rewards from iteration t_{c}. Updating the training data and constructing a new learning model from the updated data effectively updates the decision policy P.

Finally, the agent history is used to create a list of commands (e.g., Cubit©R commands), which are then compiled into a journal file (step 744). If a stopping criteria is not met, the process returns to step 724.

In some example embodiments, the reinforcement learning process queries a CAD tool (e.g., Cubit©R) for specific commands to explore a space. These actions can be in the form of a command syntax that can be used in a journal file and archived for reproducibility. In some example embodiments, two categories of actions can be constructed: (1) reduce actions; and (2) connect actions.

Reduce actions are commands (e.g., Cubit©R commands) that generate a full connected sheet body representation from a single thin volume. These actions build the reduced form of the 3D volume without consideration of neighboring connections. Examples of reduce actions include the following Cubit©R commands:

```
  (a) reduce {volume <ids>} thin copy {surface <ids>} loft factor
<value>... thickness <value>... [delete] [preview];
  (b) reduce {volume <ids>} thin midsurface {surface <ids>} loft factor
<value> thickness <value> [delete] [preview]; and
  (c) merge volume {volume <ids>}.
```

Connect Actions are commands that tweak sheet bodies to fill gaps and imprint/merge operations that connect neighboring sheet bodies from neighboring 3D thin solid volumes. Examples of connect actions include the following Cubit©R commands:

(a) tweak curve <id_list> target surface <id_list> [preview];
(b) tweak curve <id_list> target curve <id_list> [preview];
(c) tweak curve <id> <id> corner [preview];
(d) imprint volume {volume <ids>}; and
(e) merge volume {volume <ids>}.

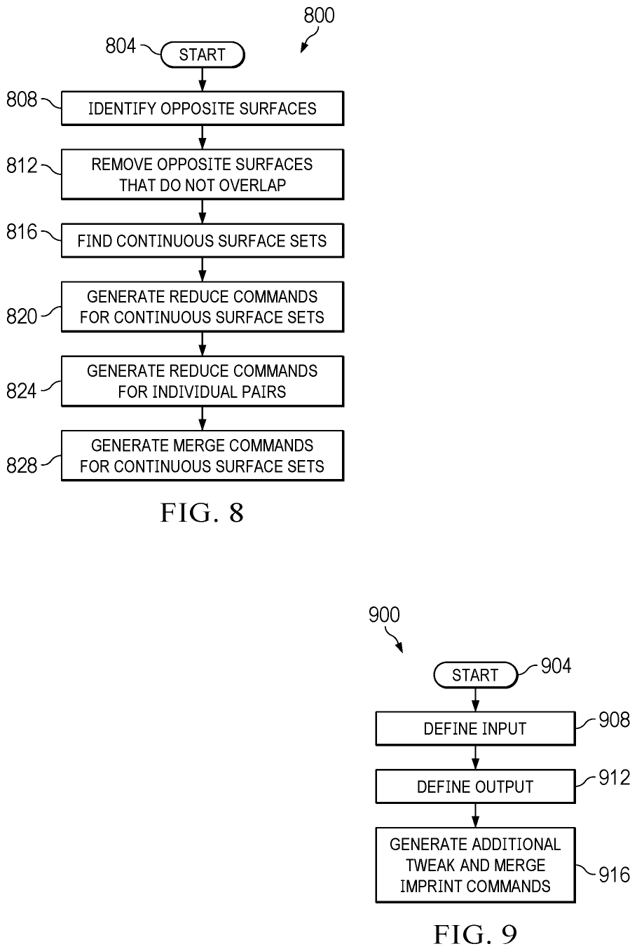

FIG. 8 depicts a flowchart of process 800 for generating reduce actions for a thin volume in accordance with an illustrative embodiment. Process 800 may include a list of commands (e.g., Cubit©R commands) for reducing the thin volume to sheet bodies.

Process starts at step 804. Pairs of surfaces that lie on opposite sides of the 3D thin volume are identified (step 808). Thus, opposite surface pairs of the 3D thin volume are identified. Also, a distance between the opposite surface pairs is computed as a thickness value for composing commands. Any opposite surface pair that does not overlap by more than a small percentage (e.g., 2%, 3%, 5%) or that have a large difference in surface area is removed (step 812). For complex volumes, a list of surface pairs is examined to find continuous surface sets which are defined as surfaces with common curves (step 816).

A reduce thin copy command is generated for each continuous surface set (step 820). The thickness value (distance) at each surface is used in the command.

Reduce commands are then generated for individual surface pairs (step 824). For example, two reduce thin copy and one reduce thin mid-surface commands are generated for each set of opposite surface pairs. The distance between the pair is used as the thickness and the loft as 0 or 0.5 for copy and mid-surface commands, respectively. Finally, merge commands are generated for continuous surface sets (step 828). For copy commands that include more than one surface, a merge operation results in a single manifold set of surfaces.

FIG. 9 depicts a flowchart of process 900 for generating connection actions for a 3D thin volume in accordance with an illustrative embodiment.

Process starts at step 904. An input is defined (step 908) which in some example embodiments may comprise two sets of sheet bodies, the thickness of the sheet bodies and optionally a close entity. The two sets of sheet bodies are sheets that are children of neighboring (touching) thin volumes. The close entity is defined as a curve or a surface at or close to the connection from the 3D thin volume.

An output comprising a list of commands for connecting the sheet bodies is defined (step 912). In some example embodiments, the output comprises a list of Cubit©R commands for connecting the sheet bodies. Thereafter, additional Cubit©R tweak and merge/imprint commands are generated (step 916):

(1) Curve to surface tweak commands: Curve to surface tweak commands are often utilized by a short-long connection. These commands are used when distance between the sheet bodies is <2×thickness and angle between their normals at their closest point is 90°±45°.

(2) Curve to curve tweak commands: Curve to curve tweak commands are often needed by a short-short connection when surfaces are in the same plane, distance between the sheet bodies is <2×thickness and angle between their normals at their closest point is 0°δ±°.

(3) Corner tweak commands: corner tweak commands are often needed by a short-long connection when two surfaces can be simultaneously extended to intersect at a single curve. These commands are used when a distance between the sheet bodies is <2×thickness and angle between their normals at their closest point is 90°±45°.

(4) Imprint/merge commands: imprint/merge commands are used to imprint and merge the sheet bodies. These commands are used when distance between the sheet bodies is <δ.

(5) Repeat tweak or imprint/merge commands for each surface in the sheet body sets: Reduction solutions that have more than one surface may require additional tweak or imprint/merge commands to effectively connect to their neighbor.

(6) Remove solutions not at connection: If a close_entity is provided, the solutions that do not involve operations in the vicinity of the close_entity are removed.

FIG. 10 depicts a flowchart of process 1000 for choosing actions for a 3D thin volume in accordance with an illustrative embodiment. Process starts at step 1004. Inputs are defined (step 1008). In some example embodiments, the inputs may include the following:

Agent: An agent represents a single 3D thin volume.

Iteration: Iteration refers to the current reinforcement learning iteration.

Initialization of random rewards: This refers to the determination whether to initialize with random rewards or from supervised learning predictions.

Random Probability: Random probability is defined as the probability for selection of a random reward.

Learning Interval: Supervised learning model is updated at reinforcement learning iterations evenly divisible by learning interval.

Next, an output is defined. The output may comprise one or more actions (step 1012). In some example embodiments, the output comprises one or more Cubit©R commands.

With the inputs and outputs defined, the agent selects an action from a list of valid actions (step 1016). In some example embodiments, the agent selects Cubit©R commands based on one of the following criteria:

(1) Initialization/Reinitialization from supervised learning: if (t=0 and init_random=false) or iteration mod learning interval=0, the agent selects the action from the last iteration. This presumes that the training model has been updated after the last iteration.

(2) Initialization from random: if t=0, init_random=true and t mod learning interval NOT=0, the agent selects a random action. If total number of actions for this agent is 2, the agent selects the other action.

(3) Random exploration: If a random number, ρ (0<ρ<1)≤random_probability and max action reward, rₐ<1.0, the agent selects a random action.

(4) Weighted action: If ρ>random_probability, the agent selects the reward from the agent's recent reward history based on a decaying weighted average, such that more recent iterations are given a preference.

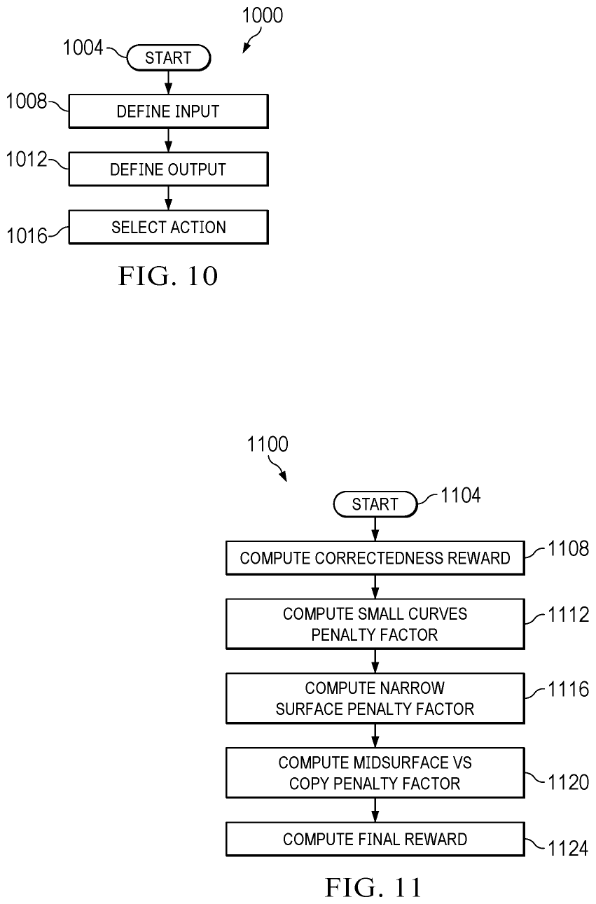

FIG. 11 depicts a flowchart of process 1100 for choosing a reward policy (R) for the reduction of a 3D thin volume in accordance with an illustrative embodiment. Process starts at step 1104. An initial connectedness reward (re) is computed based on the number of successful connections to the reduced sheet body solution (step 1108). If the reduced sheet body solution maintains all the expected connections to its parent 3D volume, r_{c} is set to 1.0. For example, if a volume is connected to three neighboring volumes and its reduced sheet body representation accurately preserves these connections, r_{c} is set to 1.0. If only a subset of the expected connections is maintained, r_{c} is adjusted accordingly. For instance, if 2 out of 3 connections are preserved, r_{c} is set to 0.666.

A small curves penalty factor (p_{c}) is computed if the reduction action introduces small curves (step 1112). The penalty factor (p_{c}) is set to 0.9 for each additional small curve generated. In the present disclosure, small curves are defined as curves with a length smaller than the thickness. The penalty factor ensures that actions leading to a reduced model with fewer small curves are favored.

A narrow surface penalty factor (pₛ) of 0.9 is computed if the reduction action generates narrow surfaces (step 1116). In the present disclosure, narrow surfaces are defined as surfaces with a width smaller than the thickness. The narrow surface penalty factor encourages actions that result in reduced models with wider surfaces.

An additional mid-surface vs copy penalty factor (pₘ) of 0.9 is introduced if a copy surface operation is used instead of a mid-surface operation when both options are available (step 1120). The penalty factor pₘ prioritizes mid-surface operations if preferred by the user or if it produces more favorable reductions. If the preferred mid-surface operation is used or if no mid-surface operation is available, pₘ is set to 1.0.

A final reward (rₐ) assigned by the agent for its action is calculated (step 1124). In some example embodiments, rₐ is expressed by the following equation:

rₐ=r_{c}×p_{C}^{NSC}×pₛ^{NNS}×pm, where NSC represents the number of small curves generated and NNS represents the number of narrow surfaces generated. The reward policy ensures that actions leading to reduced models with better connectedness, fewer small curves, wider surfaces, and preferred reduction methods are favored and receive higher rewards.

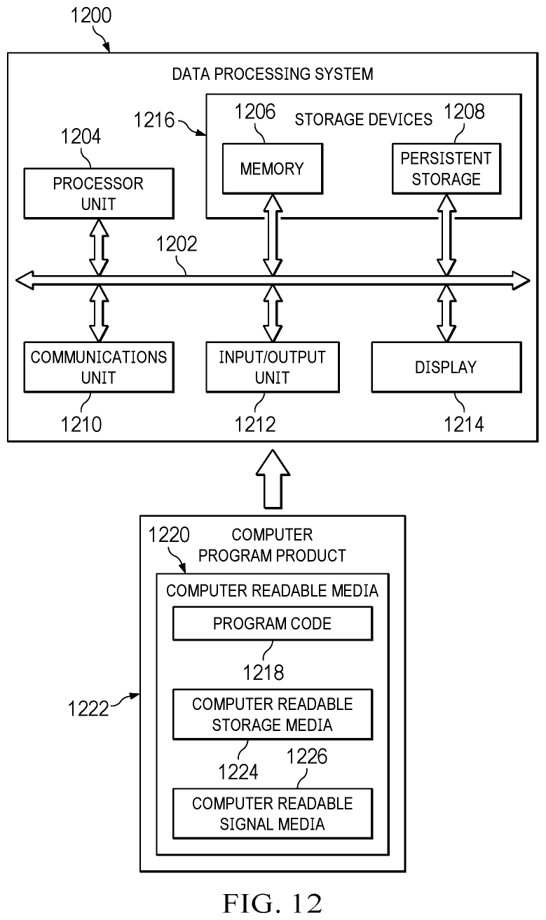

Turning now to FIG. 12, an illustration of a block diagram of a data processing system is depicted in accordance with an illustrative embodiment. Data processing system 1200 may be used to implement server computer 104 and server computer 106 and client devices 110 in FIG. 1, as well as system 200 in FIG. 2. In this illustrative example, data processing system 1200 includes communications framework 1202, which provides communications between processor unit 1204, memory 1206, persistent storage 1208, communications unit 1210, input/output unit 1212, and display 1214. In this example, communications framework 1202 may take the form of a bus system.

Processor unit 1204 serves to execute instructions for software that may be loaded into memory 1206. Processor unit 1204 may be a number of processors, a multi-processor core, or some other type of processor, depending on the particular implementation. In an embodiment, processor unit 1204 comprises one or more conventional general-purpose central processing units (CPUs). In an alternate embodiment, processor unit 1204 comprises one or more graphical processing units (GPUs).

Memory 1206 and persistent storage 1208 are examples of storage devices 1216. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1216 may also be referred to as computer-readable storage devices in these illustrative examples. Memory 1206, in these examples, may be, for example, a random access memory or any other suitable volatile or non-volatile storage device. Persistent storage 1208 may take various forms, depending on the particular implementation.

For example, persistent storage 1208 may contain one or more components or devices. For example, persistent storage 1208 may be a hard drive, a flash memory, a rewritable optical disk, a rewritable magnetic tape, or some combination of the above. The media used by persistent storage 1208 also may be removable. For example, a removable hard drive may be used for persistent storage 1208. Communications unit 1210, in these illustrative examples, provides for communications with other data processing systems or devices. In these illustrative examples, communications unit 1210 is a network interface card.

Input/output unit 1212 allows for input and output of data with other devices that may be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs may be located in storage devices 1216, which are in communication with processor unit 1204 through communications framework 1202. The processes of the different embodiments may be performed by processor unit 1204 using computer-implemented instructions, which may be located in a memory, such as memory 1206.

These instructions are referred to as program code, computer-usable program code, or computer-readable program code that may be read and executed by a processor in processor unit 1204. The program code in the different embodiments may be embodied on different physical or computer-readable storage media, such as memory 1206 or persistent storage 1208.

Program code 1218 is located in a functional form on computer-readable media 1220 that is selectively removable and may be loaded onto or transferred to data processing system 1200 for execution by processor unit 1204. Program code 1218 and computer-readable media 1220 form computer program product 1222 in these illustrative examples. In one example, computer-readable media 1220 may be computer readable storage media 1224 or computer-readable signal media 1226.

In these illustrative examples, computer readable storage media 1224 is a physical or tangible storage device used to store program code 1218 rather than a medium that propagates or transmits program code 1218. Computer readable storage media 1224, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1218 may be transferred to data processing system 1200 using computer-readable signal media 1226. Computer-readable signal media 1226 may be, for example, a propagated data signal containing program code 1218. For example, computer-readable signal media 1226 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1200 are not meant to provide architectural limitations to the manner in which different embodiments may be implemented. The different illustrative embodiments may be implemented in a data processing system including components in addition to or in place of those illustrated for data processing system 1200. Other components shown in FIG. 12 can be varied from the illustrative examples shown. The different embodiments may be implemented using any hardware device or system capable of running program code 1218.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for reducing thin volume assemblies and generating sheet bodies using reinforcement learning, comprising:
establishing respective agents for thin volumes;
selecting actions for reducing the thin volumes;
assigning initial rewards to the actions for each agent;
executing the selected actions by the agents;
assigning rewards to the selected actions based on a reward policy; and
continuing the reinforcement learning until at least one stopping criterion is met.

2. The method of claim 1, wherein the agents are responsible for selecting their actions and maintaining actions' reward history.

3. The method of claim 1, wherein the actions include a reduce thin copy operation or a mid-surface operation.

4. The method of claim 1, wherein the initial rewards are calculated using a supervised learning model for the actions.

5. The method of claim 1, wherein the actions are selected from known actions using a decision policy that allows for exploitation of a state space utilizing supervised learning predictions to exploit knowledge gained from previous iterations of the supervised learning predictions.

6. The method according to claim 1, wherein stopping criteria include reaching a predefined number of iterations or achieving a specified level of convergence of rewards for the actions.

7. The method of claim 4, wherein the supervised learning model used for predicting initial rewards employs features including geometry and neighboring thin volumes to improve prediction accuracy over iterations.

8. The method of claim 1, wherein the actions comprise reduction actions and connection actions, and wherein the reduction actions are performed before the connection actions to ensure thin volume reduction before extending, imprinting and merging neighboring sheet bodies.

9. The method of claim 1, wherein the actions are assigned rewards based on a reward policy that considers geometric integrity and connection relationships between the thin volumes and neighboring sheet bodies.

10. A system for reducing thin volume assemblies and generating sheet bodies using reinforcement learning, the system comprising:
a storage device configured to store program instructions; and
one or more processors operably connected to the storage device and configured to execute the program instructions to cause the system to:
establish respective agents for thin volumes;
select actions for reducing the thin volumes;
assign initial rewards to the actions for each agent;
execute the selected actions by the agents;
assign rewards to the selected actions based on a reward policy; and
continue the reinforcement learning until at least one stopping criterion is met.

11. The system of claim 10, wherein the agents are responsible for selecting their actions and maintaining actions' reward history.

12. The system of claim 10, wherein the actions include a reduce thin copy operation or a mid-surface operation.

13. The system of claim 10, wherein the initial rewards are calculated using a supervised learning model for the actions.

14. The system of claim 10, wherein the actions are selected from known actions using a decision policy that allows for exploitation of a state space utilizing supervised learning predictions to exploit knowledge gained from previous iterations of the supervised learning predictions.

15. The system of claim 10, wherein stopping criteria include reaching a predefined number of iterations or achieving a specified level of convergence of rewards for the actions.

16. The system of claim 14, wherein the supervised learning model used for predicting initial rewards employs features including geometry and neighboring thin volumes to improve prediction accuracy over iterations.

17. The system of claim 10, wherein the actions comprise reduction actions and connection actions, and wherein the reduction actions are performed before the connection actions to ensure thin volume reduction before extending, imprinting and merging neighboring sheet bodies.

18. The system of claim 10, wherein the actions are assigned rewards based on a reward policy that considers geometric integrity and connection relationships between the thin volumes and neighboring sheet bodies.

19. A computer program product for reducing thin volume assemblies and generating sheet bodies using reinforcement learning, the computer program product comprising:
a computer-readable storage medium having program instructions embodied thereon to perform the steps of:
establishing respective agents for thin volumes;
selecting actions for reducing the thin volumes;
assigning initial rewards to the actions for each agent,
executing the selected actions by the agents;
assigning rewards to the selected actions based on a reward policy; and
continuing the reinforcement learning until at least one stopping criterion is met.

20. The computer program product of claim 19, wherein the agents are responsible for selecting their actions and maintaining actions' reward history.

21. The computer program product of claim 19, wherein the actions include a reduce thin copy operation or a mid-surface operation.

22. The computer program product of claim 19, wherein the initial rewards are calculated using a supervised learning model for the actions.

23. The computer program product of claim 19, wherein the actions are selected from known actions using a decision policy that allows for exploitation of a state space utilizing supervised learning predictions to exploit knowledge gained from previous iterations of the supervised learning predictions.

24. The computer program product of claim 19, wherein stopping criteria include reaching a predefined number of iterations or achieving a specified level of convergence of rewards for the actions.

25. The computer program product of claim 19, wherein the supervised learning model used for predicting initial rewards employs features including geometry and neighboring thin volumes to improve prediction accuracy over iterations.

26. The computer program product of claim 19, wherein the actions comprise reduction actions and connection actions, and wherein the reduction actions are performed before the connection actions to ensure thin volume reduction before extending, imprinting and merging neighboring sheet bodies.

27. The computer program product of claim 19, wherein the actions are assigned rewards based on a reward policy that considers geometric integrity and connection relationships between the thin volumes and neighboring sheet bodies.
